(19) United States
(12) Patent Application Publication
(10) Pub. No.: US 2019/0356170 A1
(43) Pub. Date: Nov. 21, 2019

(54) RESONANCE-TYPE POWER RECEPTION DEVICE

(71) Applicant: Mitsubishi Electric Engineering Company, Limited, Chiyoda-ku (JP)

(72) Inventors: Yoshiyuki AKUZAWA, Chiyoda-ku (JP); Hiroshi MATSUMORI, Chiyoda-ku (JP)

(73) Assignee: Mitsubishi Electric Engineering Company, Limited, Chiyoda-ku (JP)

(21) Appl. No.: 16/483,248

(22) PCT Filed: Mar. 10, 2017
(86) PCT No.: PCT/JP2017/009728

§ 371 Date: Aug. 2, 2019

(51) Int. Cl. H02J 50/12; H02J 50/70

(52) U.S. Cl. CPC H02J 50/12; H02J 50/70

(57) ABSTRACT

A receiving antenna (3) receiving power transferred from a transmitting antenna (2) is provided. Further, a receiving circuit (4) controlling an input impedance in accordance with mutual inductance between the transmitting antenna and the receiving antenna is provided.

### TECHNICAL FIELD

The present invention relates to a resonance-type power reception device that receives radio frequency power.

### BACKGROUND ART

In a conventional resonance-type power transfer system, in order to suppress interfering waves and decrease in power transfer efficiency which are caused by radiation of a leakage electromagnetic field, each of a transmitting antenna and a receiving antenna is covered with a magnetic shield member (see, for example, Patent Literature 1).

### CITATION LIST

### Patent Literatures

Patent Literature 1: JP 2012-248747 A

### SUMMARY OF INVENTION

### Technical Problem

In the conventional configuration, radiation of a leakage electromagnetic field is suppressed using magnetic shield members. In such a configuration, the magnetic shield members need to cover the entire antenna while ensuring a gap with the antennas so as not to block a magnetic field between the transmitting antenna and the receiving antenna. Hence, there is a problem that the transmission device and the reception device cannot be made compact due to the structure.

Further, in the conventional configuration, though radiation of a leakage electromagnetic field generated from the transmitting and receiving antennas is suppressed, generation of a leakage electromagnetic field is not suppressed. In addition, the magnetic shield members cannot be provided in a gap between the transmitting antenna and the receiving antenna. Hence, there is a problem that a leakage electromagnetic field is radiated from this gap portion. The leakage electromagnetic field is higher harmonics of the fundamental wave for power transfer, and also acts as interfering waves over a wide band up to about 1 GHz, and adversely affects the communication frequency band of radios, radio transceivers, mobile phones, or the like.

The present invention is made to solve the above problems, and an object of the invention is to provide a resonance-type power reception device capable of suppressing generation of interfering waves without using a magnetic shield member.

### Solution to Problem

A resonance-type power reception device according to the invention includes: a receiving antenna receiving power transferred from a transmitting antenna; and a receiving circuit controlling an input impedance in accordance with mutual inductance between the transmitting antenna and the receiving antenna.

### Advantageous Effects of Invention

According to the present invention, as configured in the above-described manner, generation of interfering waves can be suppressed without using a magnetic shield member.

### BRIEF DESCRIPTION OF DRAWINGS

FIG. 1 is a diagram showing an exemplary configuration of a resonance-type power transfer system according to a first embodiment of the invention;

FIGS. 2A to 2C are diagrams describing exemplary operation of an interface power supply (V_{O}-I/F) of the first embodiment of the invention, and FIG. 2A is a diagram showing a relationship between mutual inductance M and an input voltage Vin, FIG. 2B is a diagram showing an example of control of an input current Iin, and FIG. 2C is a diagram showing an example of control of an input current Iin′ for a case of using a normal DC/DC converter; and

FIG. 3 is a diagram showing an exemplary configuration of a part of a resonance-type power reception device according to a second embodiment of the invention.

### DESCRIPTION OF EMBODIMENTS

Some embodiments of the present invention will be described in detail below with reference to the accompanying drawings.

### First Embodiment

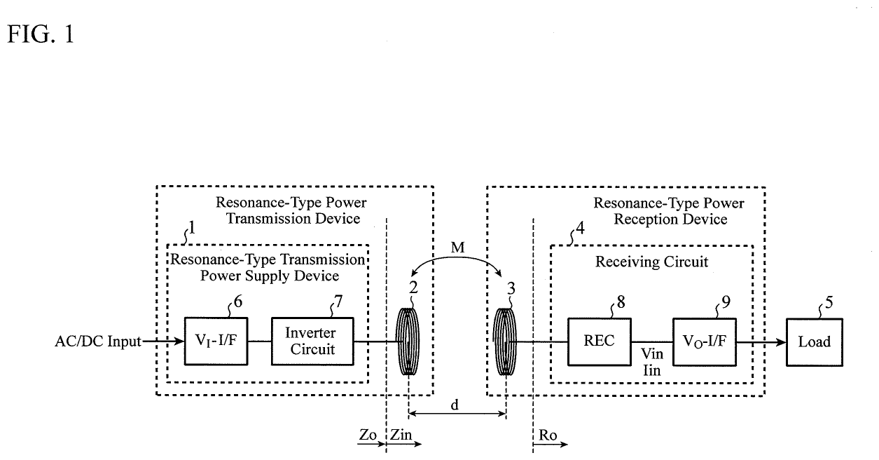

FIG. 1 is a diagram showing an exemplary configuration of a resonance-type power transfer system according to a first embodiment of the invention.

The resonance-type power transfer system includes, as shown in FIG. 1, a resonance-type transmission power supply device 1, a transmitting antenna (TX-ANT) 2, a receiving antenna (RX-ANT) 3, a receiving circuit 4, and a load 5. The resonance-type transmission power supply device 1 includes an interface power supply (V_{I}-I/F) 6 and an inverter circuit 7. The receiving circuit 4 includes a rectifier circuit (REC) 8 and an interface power supply (V_{O}-I/F) 9. The resonance-type transmission power supply device 1 and the transmitting antenna 2 form a resonance-type power transmission device, and the receiving antenna 3 and the receiving circuit 4 form a resonance-type power reception device.

The interface power supply 6 has a function of a converter that increases or decreases a voltage inputted to the resonance-type transmission power supply device 1, and outputs direct current (DC) power. The interface power supply 6 has a function of a DC/DC converter when DC power is inputted to the resonance-type transmission power supply device 1, and has a function of an AC/DC converter when alternating current (AC) power is inputted to the resonance-type transmission power supply device 1. The power obtained by the interface power supply 6 is outputted to the inverter circuit 7.

The inverter circuit 7 converts the power outputted from the interface power supply 6 into radio frequency power having the same (“the same” includes the meaning of “substantially the same”) frequency as the resonance frequency of the transmitting antenna 2, and outputs the radio frequency power. The inverter circuit 7 is an inverter circuit of a resonant switching type such as a class-E inverter circuit.

The transmitting antenna 2 resonates at the same (“the same” includes the meaning of “substantially the same”) frequency as the frequency of the radio frequency power outputted from the inverter circuit 7, and thereby performs power transfer.

The receiving antenna 3 resonates at the same (“the same” includes the meaning of “substantially the same”) frequency as the resonance frequency of the transmitting antenna 2, and thereby receives the radio frequency power transferred from the transmitting antenna 2. The radio frequency power (AC power) received by the receiving antenna 3 is outputted to the rectifier circuit 8.

Note that the power transfer type between the transmitting antenna 2 and the receiving antenna 3 is not particularly limited, and any of a magnetic field resonance-type, an electric field resonance-type, and an electromagnetic induction-type may be used. In addition, the transmitting antenna 2 and the receiving antenna 3 are not limited to contactless antennas such as those shown in FIG. 1.

The rectifier circuit 8 converts the AC power outputted from the receiving antenna 3 into DC power. The DC power obtained by the rectifier circuit 8 is outputted to the interface power supply 9.

The interface power supply 9 has a function of a DC/DC converter that increases or decreases the DC voltage outputted from the rectifier circuit 8. The DC power obtained by the interface power supply 9 is outputted to the load 5.

Further, the interface power supply 9 has a function of controlling an input impedance Zin of the transmitting antenna 2 by controlling an input impedance Ro of the rectifier circuit 8 (the receiving circuit 4) in accordance with mutual inductance M between the transmitting antenna 2 and the receiving antenna 3. Specifically, the interface power supply 9 controls a ratio between the voltage (input voltage) Vin and current (input current) Tin of the above-described DC power to a value proportional to the square of the above-described mutual inductance M. Note that the interface power supply 9 indirectly detects a change in the above-described mutual inductance M on a basis of a change in the above-described input voltage Vin.

The load 5 is a circuit or a device that functions by the DC power outputted from the interface power supply 9.

Next, functions of the interface power supply 9 of the first embodiment will be described.

Here, the output impedance of the inverter circuit 7 is represented as Zo. The input impedance of the transmitting antenna 2 is represented as Zin. The input impedance of the rectifier circuit 8 is represented as Ro. The inductance of the transmitting antenna 2 is represented as L_{TX}. The inductance of the receiving antenna 3 is represented as L_{RX}. The mutual inductance between the transmitting antenna 2 and the receiving antenna 3 is represented as M. The distance between the transmitting antenna 2 and the receiving antenna 3 is represented as d. The input voltage of the interface power supply 9 is represented as Vin. The input current of the interface power supply 9 is represented as Iin.

Here, the input impedance Zin of the transmitting antenna 2 is represented by the following equation (1). In equation (1), ω=2πf, and f is the transfer frequency.

Zin=(ωM)²/Ro (1)

The input impedance Ro of the rectifier circuit 8 is represented by the following equation (2). In equation (2), it is assumed that there is almost no loss in the rectifier circuit 8.

Ro≈Vin/Iin (2)

From equations (1) and (2), the input impedance Zin of the transmitting antenna 2 is given by the following equation (3):

Zin≈(ωM)²/(Vin/Iin) (3)

The mutual inductance M between the transmitting antenna 2 and the receiving antenna 3 is represented by the following equation (4). In equation (4), K is the coupling coefficient between the inductance L_{TX} of the transmitting antenna 2 and the inductance L_{RX} of the receiving antenna 3, and is in inverse proportion to the distance d between the transmitting antenna 2 and the receiving antenna 3. Thus, when the distance d between the transmitting antenna 2 and the receiving antenna 3 is changed, the mutual inductance M changes.

M=K√(L_{TX}L_{RX}) (4)

Thus, the interface power supply 9 controls Vin/Iin Ro) such that Vin/Iin is in proportion to the square of the mutual inductance M. As a result, the input impedance Zin≈(ωM)²/(Vin/Iin) of the transmitting antenna 2 becomes constant.

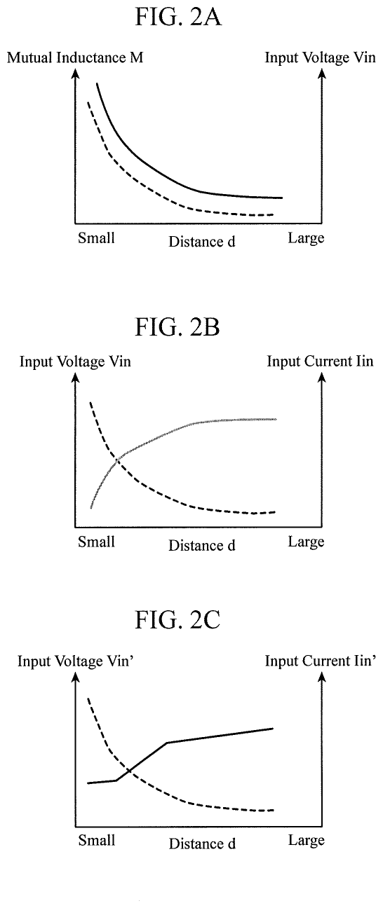

Note that the interface power supply 9 cannot directly detect the mutual inductance M between the transmitting antenna 2 and the receiving antenna 3. Meanwhile, as shown in FIG. 2A, in accordance with the change in the mutual inductance M (a solid line shown in FIG. 2A), the input voltage Vin (a dashed line shown in FIG. 2A) changes. In FIG. 2A, the horizontal axis represents the distance d between the transmitting antenna 2 and the receiving antenna 3, the left vertical axis represents the mutual inductance M, and the right vertical axis represents the input voltage Vin of the interface power supply 9.

Hence, the interface power supply 9 indirectly detects a change in the mutual inductance M by detecting a change in the input voltage Vin. Then, as shown in FIG. 2B, the interface power supply 9 controls the input current Iin (a solid line shown in FIG. 2B) such that the input current Iin changes in inverse proportion to the detected input voltage Vin (a dashed line shown in FIG. 2B). Thus, the interface power supply 9 can control Vin/Iin (≈Ro). In FIG. 2B, the horizontal axis represents the distance d between the transmitting antenna 2 and the receiving antenna 3, the left vertical axis represents the input voltage Vin of the interface power supply 9, and the right vertical axis represents the input current Tin of the interface power supply 9.

By the above control, the relationship Zo≈Zin can be maintained and impedance matching between the resonance-type power transmission device and the resonance-type power reception device is achieved, and thus, generation of interfering waves can be suppressed.

FIG. 2C shows a case in which the same control as that performed by the interface power supply 9 is performed using a normal DC/DC converter. In FIG. 2C, the horizontal axis represents the distance d between the transmitting antenna 2 and the receiving antenna 3, the left vertical axis represents the input voltage Vin′ of the normal DC/DC converter, and the right vertical axis represents the input current Iin′ of the normal DC/DC converter.

As shown in this FIG. 2C, when a normal DC/DC converter is used, the input current Iin′ (a solid line shown in FIG. 2C) cannot be controlled such that the input current Iin′ changes in inverse proportion to the input voltage Vin′ (a dashed line shown in FIG. 2C). This is because in the normal DC/DC converter the input-output conversion efficiency of the DC/DC converter changes in accordance with the level of the input voltage Vin′, and thus, due to the influence thereof, the slope of the input current Iin′ changes.

On the other hand, the interface power supply 9 has a function of compensating for fluctuations in the input current Iin′ (nonlinear characteristics of the input current Iin′ with respect to the input voltage Vin′) caused by a change in the input-output conversion efficiency of the normal DC/DC converter. As a specific example, in the interface power supply 9, a shunt circuit that increases or decreases the input current Iin in accordance with the level of the input voltage Vin is added, in addition to the function of the normal DC/DC converter. Alternatively, in the interface power supply 9, a series regulator circuit that allows the level of voltage drop to change in accordance with the level of the input voltage Vin is added, in addition to the function of the normal DC/DC converter.

As described above, according to the first embodiment, since the interface power supply 9 is provided that controls the input impedance Ro of the rectifier circuit 8 in accordance with the mutual inductance M between the transmitting antenna 2 and the receiving antenna 3, generation of interfering waves can be suppressed without using a magnetic shield member.

Specifically, in the resonance-type power transfer system, interfering waves are generated due to an input/output impedance mismatch between circuits forming the resonance-type power transmission device and the resonance-type power reception device.

For this, by controlling the input impedance Ro in accordance with the mutual inductance M by the interface power supply 9, the above-described input/output impedance mismatch between the circuits can be overcome, and thus, generation of interfering waves can be suppressed.

In addition, in the resonance-type power transfer system, interfering waves are also generated due to parasitic impedance in each circuit forming the resonance-type power transmission device and the resonance-type power reception device.

For this, by controlling the input impedance Ro in accordance with the mutual inductance M by the interface power supply 9, the above-described input/output impedance mismatch between the circuits can be overcome, and thus, the level of harmonics entering each circuit can be reduced as much as possible. As a result, even if parasitic impedance is present in the circuits, a resonance phenomenon in which harmonics are amplified is reduced. Thus, generation of interfering waves can be suppressed.

Further, in the resonance-type power transfer system, when positional displacement occurs between the transmitting and receiving antennas 2 and 3 due to a change in the position of the resonance-type power reception device, an impedance mismatch occurs between the resonance-type power transmission device and the resonance-type power reception device, and thus, interfering waves are generated.

For this, the interface power supply 9 controls the input impedance Ro in accordance with the mutual inductance M that changes depending on the distance d between the transmitting antenna 2 and the receiving antenna 3. Hence, even if positional displacement occurs between the transmitting and receiving antennas 2 and 3 due to a change in the position of the resonance-type power reception device, impedance matching between the resonance-type power transmission device and the resonance-type power reception device can be maintained, and thus, generation of interfering waves can be suppressed.

Moreover, in the resonance-type power reception device according to the first embodiment, generation of interfering waves is suppressed by circuit design. Hence, a system having high power transfer efficiency with small power loss can be formed. In addition, since a device can be formed without using a magnetic shield member, a reduction in cost, downsizing, and a reduction in weight can be achieved.

### Second Embodiment

The first embodiment shows a case in which the interface power supply 9 controls the input impedance Zin of the transmitting antenna 2 by controlling the input impedance Ro of the rectifier circuit 8 in accordance with the mutual inductance M between the transmitting antenna 2 and the receiving antenna 3. Meanwhile, the input impedance Zin of the transmitting antenna 2 includes not only a real part component R due to pure resistance, but also an imaginary part (reactance) component X due to capacitance C or inductance L. However, the interface power supply 9 of the first embodiment cannot compensate for such an imaginary part component X. Hence, in order for the output impedance Zo of the inverter circuit 7 and the input impedance Zin of the transmitting antenna 2 to match, a resonance-type power reception device according to a second embodiment compensates for the imaginary part component X included in the input impedance Zin.

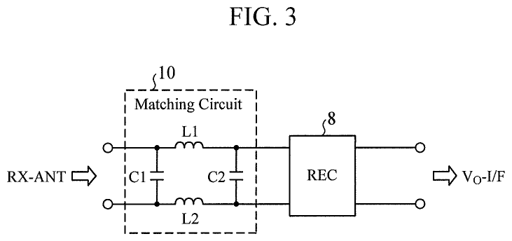

FIG. 3 is a diagram showing an exemplary configuration of a part of the resonance-type power reception device according to the second embodiment of the invention. In the resonance-type power reception device according to the second embodiment shown in this FIG. 3, a matching circuit 10 (capacitors C1 and C2 and inductors L1 and L2) is added to the resonance-type power reception device according to the first embodiment shown in FIG. 1. Other configurations are the same and thus are denoted by the same reference signs and description thereof is omitted.

The matching circuit 10 (capacitors C1 and C2 and inductors L1 and L2) is disposed between the receiving antenna 3 and the rectifier circuit 8, and compensates for the imaginary part component X of the input impedance Zin of the transmitting antenna 2. The matching circuit 10 may be any of a fixed matching type in which the constants of elements included in the matching circuit 10 are fixed, a variable matching type in which the constants of the elements are variable, and an automatic matching type in which matching is achieved by automatically changing the constants of the elements.

One end of the capacitor C1 is connected to one terminal of a pair of input terminals connected to the receiving antenna 3, and the other end of the capacitor C1 is connected to the other terminal of the pair of input terminals.

One end of the inductor L1 is connected to the one end of the capacitor C1.

One end of the inductor L2 is connected to the other end of the capacitor C1.

One end of the capacitor C2 is connected to the other end of the inductor L1 and one terminal of a pair of input terminals included in the rectifier circuit 8, and the other end of the capacitor C2 is connected to the other end of the inductor L2 and the other terminal of the pair of input terminals.

Here, the input impedance Zin of the transmitting antenna 2 is represented by the following equation (5):

Zin=R+X=√(R²+(ωL−(1/ωC))²) (5)

Then, the matching circuit 10 compensates for the imaginary part component X of the input impedance Zin of the transmitting antenna 2 by a combination of the capacitors C1 and C2 and the inductors L1 and L2. By this, an effect of suppressing generation of interfering waves is enhanced comparing with the first embodiment.

The above description shows a case in which the matching circuit 10 includes all of the capacitors C1 and C2 and the inductors L1 and L2. However, no limitation is intended, and the matching circuit 10 may include at least any one of the capacitors C1 and C2 and the inductors L1 and L2. For example, the matching circuit 10 may include only the capacitor C1, or may include only the capacitor C2 and the inductors L1 and L2, or may include only the capacitor C1 and the inductors L1 and L2.

The design of elements included in the matching circuit 10 is determined by, for example, simulating the value of the input impedance Zin upon designing a system, or actually measuring the input impedance Zin after designing a system.

Note that in the invention of the present application, a free combination of the embodiments, modifications to any component of the embodiments, or omissions of any component in the embodiments are possible within the scope of the invention.

### INDUSTRIAL APPLICABILITY

Resonance-type power reception devices according to the present invention can suppress generation of interfering waves without using a magnetic shield member, and are suitable for use as resonance-type power reception devices that receive radio frequency power, etc.

### REFERENCE SIGNS LIST

1: Resonance-type transmission power supply device, 2: Transmitting antenna (TX-ANT), 3: Receiving antenna (RX-ANT), 4: Receiving circuit, 5: Load, 6: Interface power supply (V_{I}-I/F), 7: Inverter circuit, 8: Rectifier circuit (REC), 9: Interface power supply (V_{O}-I/F), and 10: Matching circuit.

1. A resonance-type power reception device comprising:
a receiving antenna receiving power transferred from a transmitting antenna; and
a receiving circuit controlling an input impedance in accordance with mutual inductance between the transmitting antenna and the receiving antenna.

2. The resonance-type power reception device according to claim 1, wherein
the receiving circuit includes:
a rectifier circuit conversing the power received by the receiving antenna into direct current power; and
an interface power supply controlling a ratio between a voltage and a current of the direct current power obtained by the rectifier circuit to a value proportional to a square of the mutual inductance.

3. The resonance-type power reception device according to claim 2, wherein the interface power supply indirectly detects a change in the mutual inductance from a change in the voltage of the direct current power.

4. The resonance-type power reception device according to claim 1, further comprising a matching circuit disposed between the receiving antenna and the receiving circuit and compensating for an imaginary part component of an input impedance of the transmitting antenna.

5. The resonance-type power reception device according to claim 4, wherein the matching circuit includes at least one of an inductor and a capacitor.

6. The resonance-type power reception device according to claim 1, wherein the receiving antenna performs power transfer with the transmitting antenna by magnetic field resonance, electric field resonance, or electromagnetic induction.
